(19) United States
(12) Patent Application Publication
(10) Pub. No.: US 2006/0248086 A1
(43) Pub. Date: Nov. 2, 2006

(54) STORY GENERATION MODEL

(75) Inventor: Michel Pahud, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: MICROSOFT ORGANIZATION, Redmond, WA (US)

(21) Appl. No.: 10/908,210

(22) Filed: May 2, 2005

(51) Int. Cl. G06F 17/30

(52) U.S. Cl. 707/10

(57) ABSTRACT

Story generation models are disclosed for assisting users, such as young children, to create stories, for example. These story generation models may implement several tools for helping users manipulate sophisticated images, such as for changing the perspective view of any images being incorporated into a story being created, for example. Other tools may be provided that may request the users to handwrite or type the names of any selected images they may desire incorporating into a story for educational purposes. The story generation models may also implement tools for defining and/or enforcing rules during the story generation process, such as requesting the users to spell correctly and/or providing the correct spelling for any misspellings, for example. Further, the story generation models may utilize tools for enabling users to collaborate in real time, such as by allowing the users to see other's story contributions. Still further, the story generation models may provide moderator features for enabling monitoring of the story generation process. These moderator features may also be used for providing feedback to the users to help them improve their story telling skills.

### TECHNICAL FIELD

The technology relates generally to story generation and, more particularly, to a story generation model implementing various tools that may assist users with manipulating sophisticated graphics objects for generating stories individually or in a collaborative setting without requiring any special skills or knowledge on the user's part.

### BACKGROUND

A number of graphics editing applications may exist for enabling image content to be accessed, edited and/or arranged in various ways. People may often lack sufficient artistic, design, technical and/or other skills, however, which may be needed to leverage such image content to create and/or illustrate stories, for example. For instance, young children who may be extremely bright, imaginative, creative and otherwise ideal story tellers may often struggle with leveraging such content for use in telling stories. A number of factors may contribute to their struggles, such as their lack of physical coordination, manual dexterity or experience.

### BRIEF DESCRIPTION OF THE DRAWINGS

The foregoing summary will become more readily appreciated as the same becomes better understood by reference to the following detailed description, when taken in conjunction with the accompanying drawings, wherein:

FIG. 1 is a functional block diagram providing a high-level perspective of an exemplary environment in which the disclosed story generation model may be implemented to generate a story;

FIG. 2 is a block diagram of an exemplary computing device that may be used in the exemplary environment illustrated in FIG. 1 for implementing the disclosed story generation model;

FIG. 3 is a block diagram of an exemplary story generation system that may be implemented in the disclosed story generation model;

FIG. 4 is a flow chart of an exemplary method that may be implemented for generating a story in the disclosed story generation model; and

FIGS. 5-9 are diagrams of exemplary graphical user interfaces that may be employed in the disclosed story generation model.

### DETAILED DESCRIPTION

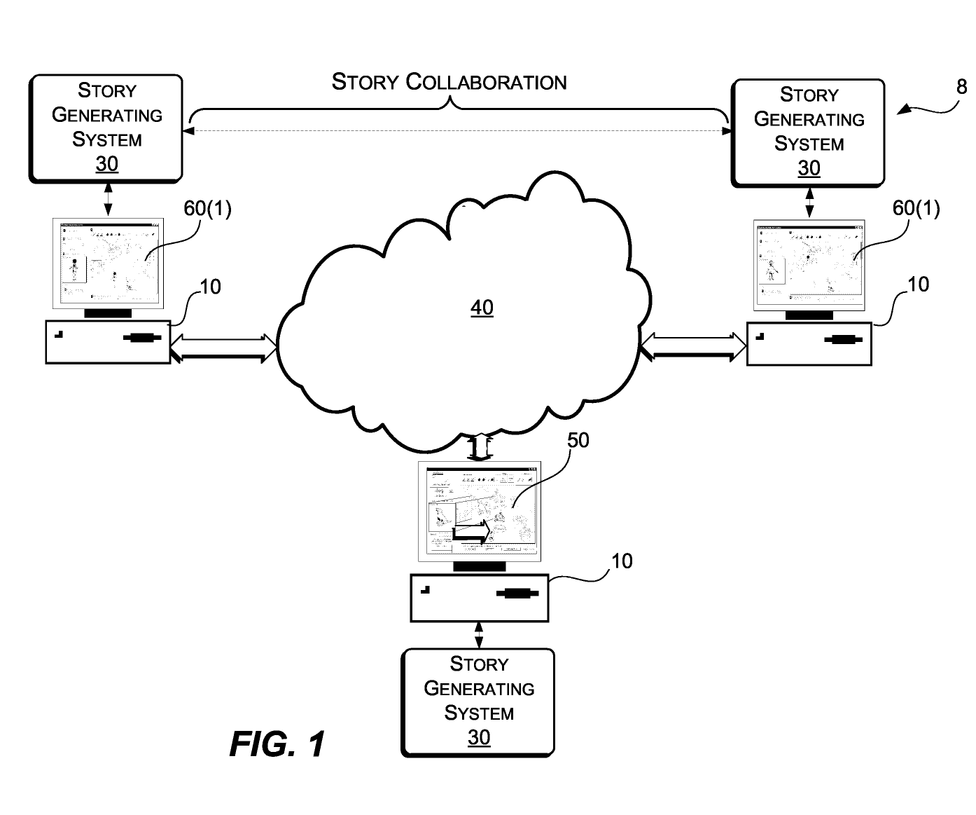

An exemplary environment 8 that may be created by implementing a story generation model is generally shown in FIG. 1. The exemplary environment depicted in FIG. 1 is presented to provide a high-level introduction of at least some of the concepts presented in this disclosure as a precursor to a more detailed description of those and perhaps other concepts further herein. As shown in FIG. 1, one or more computers 10 may implement a story generating system 30. Further, a user may operate one of the computers 10 implementing a story generation system 30 to individually generate a story on an exemplary graphical user interface (“GUI”) 50, although several other users may operate other computers 10 also implementing a story generation system 30 to collaboratively generate a story on their collaborative user interfaces 60(1) and 60(2). This exemplary environment may not only enhance users' abilities to generate entertaining stories without expending an undue amount of effort in a fun and educational way, but the general principles discussed further herein may be extended onto a number of other settings besides story generation, such as supporting individual or collaborative graphical animation in general.

Distributed or collaborative learning may enhance the learning process, particularly in the areas of communication and team work. A fun and effective way to further enhance the learning process may be to enable users, such as children, to create stories for stimulating their natural creative and analytical skills in an intuitive way. Story generating system 30 may enable users to intuitively generate stories, either individually or in a collaborative setting, which may incorporate sophisticated graphical objects (e.g., three-dimensional graphical objects, story dialog callouts, etc.) without requiring the users to posses any special graphical rendering skills or other specialized knowledge or talents. The generated stories may then be published as a series of one or more scenes that may be shared, for example.

Further, story generating system 30 may utilize one or more tools that may make generating stories fun to motivate users to operate system 30 for generating stories. For instance, story generating system 30 may request users to correctly spell the names of the images they desire incorporating into a story before allowing them to access the desired images to promote learning. Further, story generating system 30 may allow users to easily manipulate sophisticated three-dimensional images, such as for changing the perspective view of the image presented in a graphical user interface, prior to incorporated the images into the story. Providing sophisticated images, as well as rich background templates, using simple, fun and intuitive interfaces for story generation may also motivate users to use the story generating system 30. Additionally, story generating system 30 may implement tools for enabling several users to collaborate in real time while allowing each user to see the other users' contributions to the story. Still further, moderators may monitor a story being generated by collaborating users using story generation system 30 and may provide feedback to the users to further enhance the learning experience.

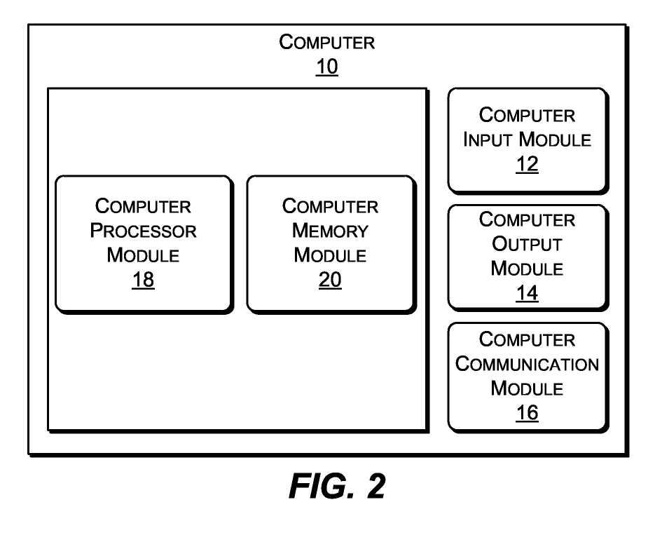

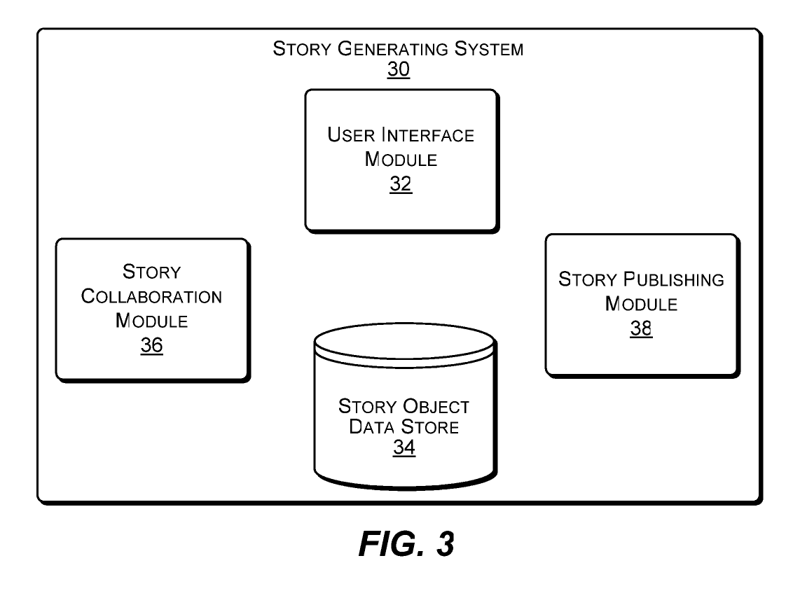

Referring now generally to FIGS. 2-3, computer 10 may be employed to implement story narration system 30. FIG. 2 illustrates an example of a suitable operating environment presented as computer 10 in which story generating system 30 may be implemented. The exemplary operating environment illustrated in FIG. 2 is not intended to suggest any limitation as to the scope of use or functionality of story generating system 30. Other types of computing systems, environments, and/or configurations that may be suitable for use with system 30 may include, but are not limited to, hand-held, notebook or laptop devices, multiprocessor systems, microprocessor-based systems, programmable consumer electronics, network PCs, minicomputers, mainframe computers, distributed computing environments that may include any of the above systems or devices, and other systems.

As such, computer 10 in its most basic configuration may comprise computer input module 12, computer output module 14, computer communication module 16, computer processor module 18 and computer memory module 20, which may be coupled together by one or more bus systems or other communication links, although computer 10 may comprise other modules in other arrangements. Computer input module 12 may comprise one or more user input devices, such as a keyboard and/or mouse, and any supporting hardware. Computer input module 12 may enable a user who is operating computer 10 to generate and transmit signals or commands to computer processor module 18.

Computer output module 14 may comprise one or more user output devices, such as a computer monitor (e.g., CRT, LCD or plasma display) and/or printer, and any supporting hardware, although other types of output devices may be used. Computer output module 14 may present one or more results from computer processor module 18 executing instructions stored in computer memory module 20.

Computer communication module 16 may comprise one or more communication interface devices, such as a serial port interface (e.g., RS-232), a parallel port interface, a wire-based (e.g., Ethernet) or wireless network adapter, and any supporting hardware, although other types of communication interface devices may be used. Computer communication module 16 may enable computer 10 to transmit data to and receive data from other computing systems or peripherals (e.g., external memory storage device, printer or other computing systems, such as other computers 10) via one or more communication media, such as network 40, although direct cable connections and/or one or more other networks may be used.

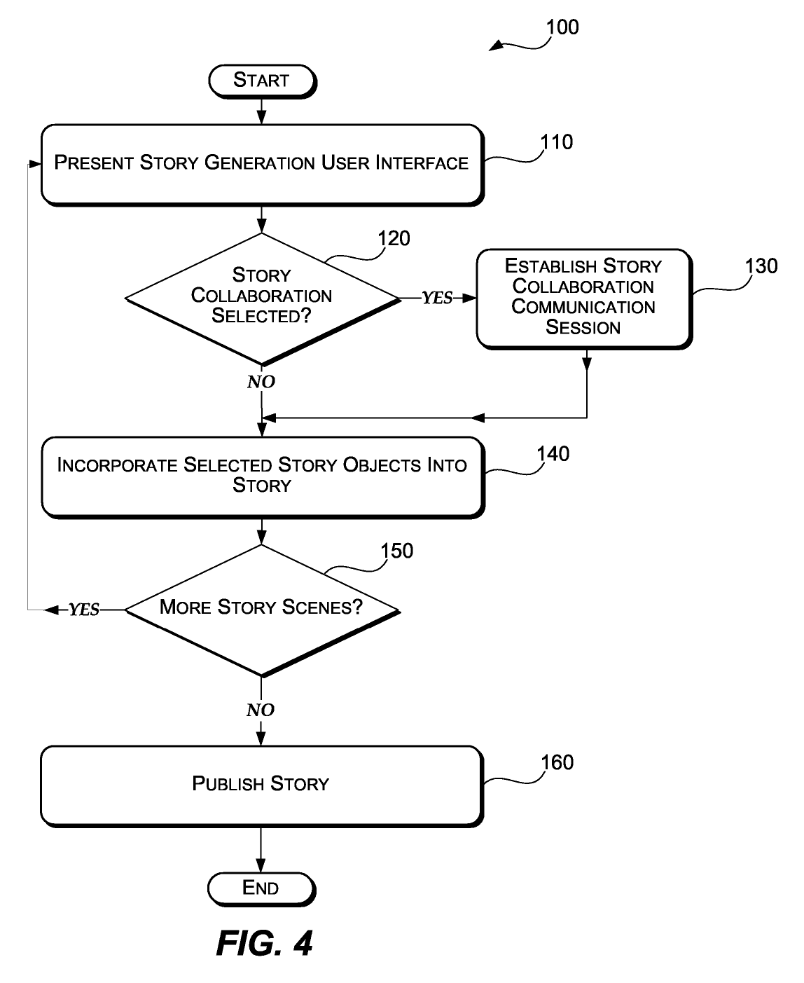

Computer processor module 18 may comprise one or more devices that may access, interpret and execute instructions and other data stored in computer memory module 20 for controlling, monitoring and managing (hereinafter referred to as “operating” and variations thereof) computer input module 12, computer output module 14, computer communication module 16 and computer memory module 20 as described herein, although some or all of the instructions and other data may be stored in and/or executed by the modules themselves. Furthermore, computer processor module 18 may also access, interpret and/or execute instructions and other data in connection with performing one or more functions to implement at least a portion of story generating system 30 and/or method 100 illustrated in FIG. 4, respectively, although processor module 18 may perform other functions, one or more other processing devices or systems may perform some or all of these functions, and processor module 18 may comprise circuitry configured to perform the functions described herein.

Computer memory module 20 may comprise one or more types of fixed and/or portable memory accessible by computer processor module 18, such as ROM, RAM, SRAM, DRAM, DDRAM, hard and floppy-disks, optical disks (e.g., CDs, DVDs), magnetic tape, ferroelectric and ferromagnetic memory, electrically erasable programmable read only memory, flash memory, charge coupled devices, smart cards, or any other type of computer-readable media, which may be read from and/or written to by one or more magnetic, optical, or other appropriate reading and/or writing systems coupled to computer processor module 18 and/or one or more other processing devices or systems.

Computer memory module 20 may store at least a portion of the instructions and data that may be accessed, interpreted and/or executed by computer processor module 18 for operating computer input module 12, computer output module 14, and computer communication module 16, although some or all of the instructions and data may be stored elsewhere, such as in the modules themselves and/or the computer processor module 18. Furthermore, computer memory module 20 may also store one or more instructions that may be accessed, interpreted and/or executed by computer processor module 18 to implement at least a portion of story generating system 30 and/or method 100 illustrated in FIG. 4, although one or more other devices and/or systems may access, interpret and/or execute the stored instructions. The one or more instructions stored in computer memory module 20 may be written in one or more conventional or later developed programming languages or other expressed using other methodologies.

Referring now to FIG. 3, an exemplary implementation of story generating system 30 is shown as comprising several modules including user interface module 32, story collaboration module 36, and story publishing module 38. Generally, one or more instructions stored in computer memory module 20 may be executed by computer processor 18 to implement at least a portion of the functionalities described further below in connection with modules 32, 36 and 38 in story generating system 30, although circuitry could be configured to implement at least a portion of those functionalities. Moreover, the one or more instructions that may be executed to implement the functionalities represented by modules 32, 36 and 38 in story generating system 30 may be stored elsewhere and/or may be executed by one or more other computing systems or devices.

It should be appreciated that story generating system 30, interface module 32, story collaboration module 36, and story publishing module 38 are illustrated in FIG. 3 to provide high-level representations of several different functionalities that may be implemented by story generating system 30 for ease of description and illustrative purposes only. Thus, this exemplary implementation of story generating system 30 should not be interpreted to require that only those illustrated modules 32, 36 and 38 be employed to operatively and/or programmatically implement system 30, since a fewer or greater number and other types of modules may be employed so long as the overall functionalities remain substantially the same as described herein.

Generally, story generating system 30 may represent a portion of the functionality that may be implemented for generating stories in the manner described further herein below in connection with method 100 illustrated in FIG. 4. Further, story generating system 30 may comprise story object data store 34. Story object data store 34 may store one or more story objects, such as graphical objects, which may be incorporated into a story being generated. It should be appreciated that story object data store 34 is illustrated in the manner shown in FIG. 3 for ease of description and illustration only to provide a high-level representation of the data that may be involved in this example of an implementation of story generating system 30. Further, the data represented by story object data store 34 may all be stored at the same location, such as at computer memory module 20, although one or more portions of the data represented by story object data store 34 may be stored elsewhere.

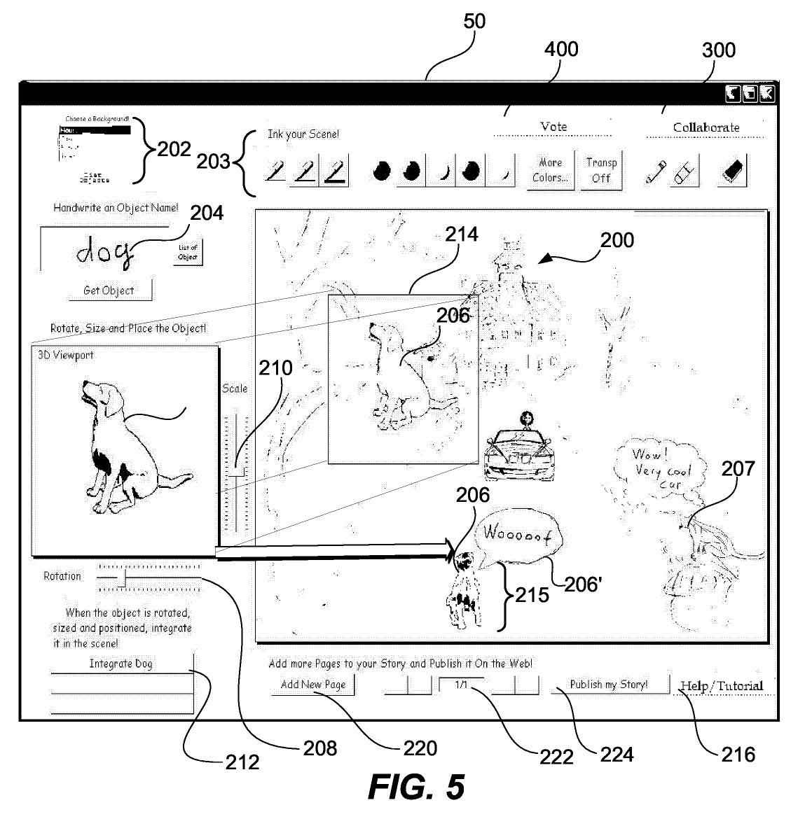

User interface module 32 may represent a portion of the functionality implemented by story generating system 30 for generating one or more graphical user interfaces that may be employed to obtain information from users that may be operating the system 30 to generate stories in method 100 illustrated in FIG. 4. Examples graphical user interfaces that may be employed by story generating system 30 are illustrated in FIGS. 5-9 described further herein below in connection with method 100.

Story collaboration module 36 may represent a portion of the functionality implemented in story generating system 30 for enabling one or more users to collaborate while generating a story. Story publishing module 38 may represent a portion of the functionality implemented in story generating system 30 for presenting a generated story. Having described each of modules 32, 36 and 38 and data stores 34 that may be implemented in story generating system 30 shown in FIG. 3, an example of their implementation for generating a story will now be described.

A method for 100 will now be described with reference to FIGS. 4-9 in the context of being carried out in the exemplary environment 8 described above in connection with FIGS. 1-3. Referring to FIG. 4, and beginning method 100 at step 110, a user of computer 10 may use computer input module 12, in conjunction with operation of the computer's output module 14, communication module 16, processor module 18 and memory module 20, to request story generating system 30 to begin operating. Story generating system 30 may respond to the user's request to begin by instructing user interface module 32 to present one or more user interfaces for presenting information to the user and for enabling the user to provide information to story generating system 30, such as an exemplary graphical user interface (“GUI”) 50 illustrated in FIG. 5.

User interface module 32 may instruct computer output module 14 to present GUI 50 using one or more of the output module 14's associated user output devices, such as a computer monitor. GUI 50 is provided for ease of illustration and description only, as any type of presentation interface besides graphical interfaces may be used. Further, the GUI 50 has been illustrated in FIG. 5 to show user interaction elements 202, 204, 206, 208, 210, 214, 216, 220, 222, 224, 400 and 300 presented together in a single interface. However, the user interaction elements may be presented in a plurality of separate graphical interfaces that may be presented during one or more particular portions of method 100 or in response to one or more particular events that may occur in method 100. Once the GUI 50 is presented, a user may select a collaborate button 300 in GUI 50 to establish a collaborative communication channel for generating a story.

At step 120, if the user selected the collaborate button 300 in GUI 50, user interface module 32 may instruct story generating system 30 that the user desires establishing a collaborative communication channel with one or more other users for generating a story, and the YES branch may be followed to step 130. Otherwise, method 100 proceeds to step 140.

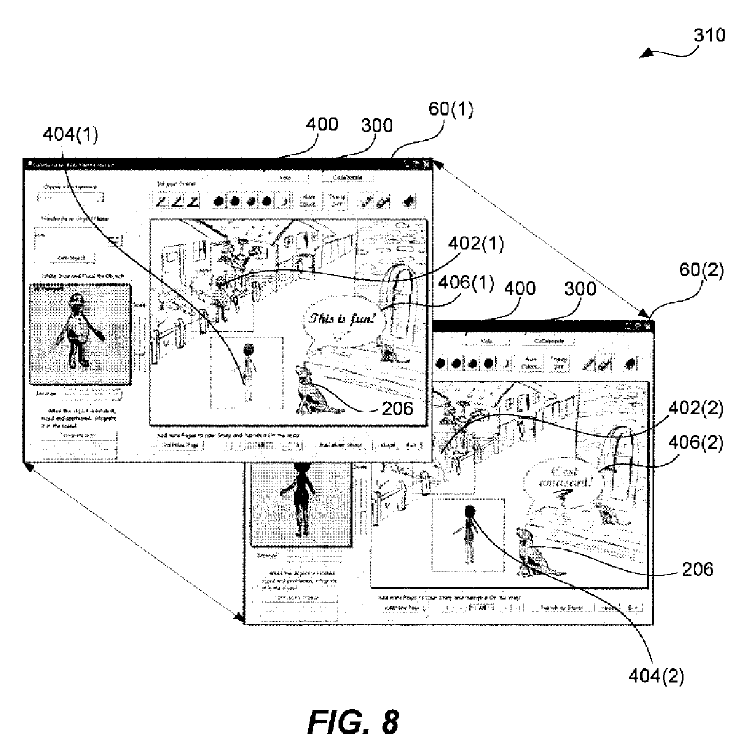

At step 130, story generating system 30 may establish a collaborative communication session 310 over network 40 between one or more users as shown in FIG. 8, such as a first user of a first computer 10 and a second user of a second computer 10 as shown in FIG. 1. In particular, story generating system 30 may present a user at one of the computers 10 with one or more user interfaces for identifying which other users they would like to collaborate with (not illustrated). The user may identify the users in a variety of ways, such as by providing the name of a computer or other device being used by the other users on the network 40.

Once story generating system 30 obtains information from the users to identify the one or more other users for which to establish a collaboration session 310, system 30 may initiate a communication session with each of the users' machines, and the systems 30 on each respective user's machines may present the one or more collaborative user interfaces 60(1)-60(2) shown in FIG. 8. Further, story generating system 30 may provide additional information regarding the status of the story being generated in the event the user requesting the collaboration has already begun generating the story.

As shown in FIG. 8, the users may select objects that may represent the user for inclusion into the story if desired, such as user objects 402(1), 402(2), for example. The story generating system 30 may have obtained a representation of the user, such as a digital picture of the user that may have been stored in computer memory module 20 and imported by story generating system 30 to be stored at story object data store 34, for example. The user interface module 32 may also indicate which story objects on the respective user's collaborative user interfaces 60(1)-60(2) may have been placed in the story by remote collaborative users or which may have been placed by local collaborative users by presenting the local and remote objects in different colors on the collaborating user's respective interfaces, for example, although the local and remote status information may be indicated in a number of other ways, such as using text to identify the local and/or remote objects. For instance, a user's name that may be associated with one or more objects included in a story may be presented on one or more of collaborative user interfaces 60(1)-60(2) when a mouse cursor is passed over the object.

By way of example only, one or more objects (e.g., user object 402(1)) in a first collaborative user interface 60(1) may be presented in a first color, such as red, while one or more other objects (e.g., user object 404(1)) in the same interface 60(1) may be presented in a second color, such as green, to indicate whether the objects are associated with a local or remote user with respect to the computer 10 generating the interface 60(1). Moreover, the user objects 402(1) and/or 404(1) and/or the color schemes used to indicate their local or remote status may be used to represent the collaborating users themselves and/or any objects included in the story by the local or remote collaborating users. Likewise, one or more objects (e.g., user object 402(2)) may be presented in the second color, such as green, in the second collaborative user interface 60(2), while one or more other objects (e.g., user object 404(2)) in the same interface 60(2) may be presented in the first color, such as red, to indicate the objects' local or remote status with respect to the computer 10 generating the interface 60(2).

Still further, users may include story captions or callouts in the same manner as described in connection with step 140 below, such as a first collaborative dog callout 406(1) in the first collaborative user interface 60(1) and a corresponding second collaborative dog callout 406(2) in the second collaborative user interface 60(2), for example. However, the user interface module 32 that may be implemented in the story generating system 30 for another computer 10 may translate the content of any text from the first collaborative dog callout 406(1) into another language that may have been selected as a default language by the other user of the other computer 10 that may be presenting the second collaborative dog callout 406(2) in the second collaborative user interface 60(2).

By way of example only, a first user may have entered text in their default language, such as English, for the first collaborative dog callout 406(1), such as “This is fun!,” which may be presented in the other user's default language, such as French, in the second collaborative dog callout 406(2) in the second collaborative user interface 60(2), such as “C'est amusement!.” As a result, collaborating users may not be limited to users located at particular countries and/or speaking any particular languages. Additionally, the callouts may be presented in different colors to indicate the local or remote status of the users that may have included the callouts in the story in the same manner described above, for example. Furthermore, If the callouts included in the story include handwritten content, the user interface module 32 may perform optical character recognition to convert the image data into text before performing the language translation, although the module 32 may present the user with one or more other user interfaces (not illustrated) requesting that the content be typed so it may be translated.

At step 140, a user may begin generating a story by selecting a background 200 for their story by accessing background selection 202 in GUI 50, for example. Responsive to the user selection, user interface module 32 in story generating system 30 may instruct computer output module 14 to present the selected background 200 in the GUI 50. The user may also select one or more default objects that may be stored in story object data store 34 for including in the story being generated. Additional graphical editing tools may be implemented by story generating system 30 and presented to the user by user interface module 32 in the form of one or more graphical editing buttons 203 in GUI 50, for example. By way of example only, these tools may enable the user to hand-draw objects on the selected background 200, color one or more objects and/or portions of the background 200, select additional colors, select one or more objects that may be made transparent, and or erase one or more objects, for example.

Further, the user may select one or more graphical objects, such as the dog object 206, for incorporating into the story. However, the user interface module 32 in story generating system 30 may be configured to provide a digital handwriting interface 204 where the user may handwrite the name of the desired object (e.g., dog object 206) for requesting the object 206 using a digital pen writing interface, for example, although other types of interfaces or writing interfaces may be used. This may help enhance learning since users (e.g., children) may need to know how to correctly spell the objects they may desire incorporating into a story to be able to request them.

Where the user interface module 32 may be configured to provide a digital handwriting interface 204 for the user to handwrite the name of a desired object, story generating system 30 may be configured to perform optical character recognition (“OCR”) on the handwritten information to determine the content of the handwritten text for a number of reasons. For instance, the user interface module 32 may be configured to instruct the user, such as a child, to ensure that the information they may be handwriting or otherwise entering, such as by typing, is correctly spelled.

Further in this example, once the story generating system 30 may recognize the content of the handwritten or typed text as the case may be where the user interface module 32 instructs the user to correctly spell the handwritten information, the system 30 may enforce one or more spelling rules and determine whether the information is spelled correctly, although other grammar rules besides spelling may be enforced. Moreover, the system 30 may provide one or more additional user interfaces (not illustrated) that may include correct spelling(s) for the handwritten or typed information to enhance the user's learning experience when generating a story, although correct grammar related information may be provided as well.

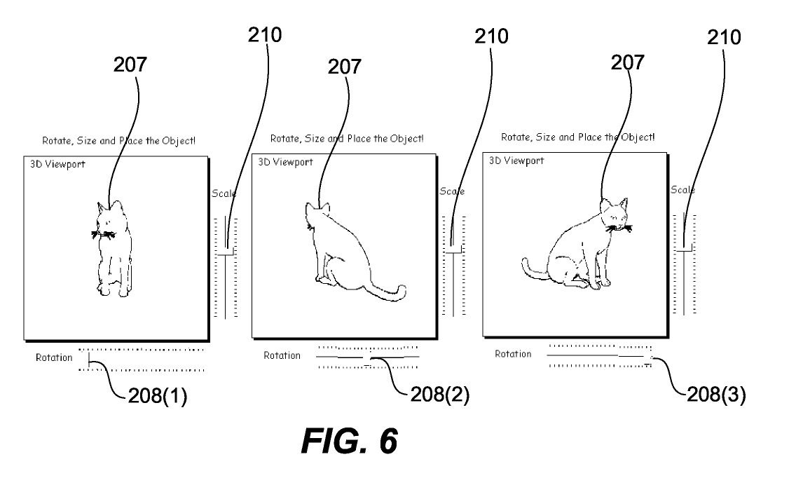

Responsive to the user's selections and/or additional information provided via one or more other interfaces (not illustrated) presented to the user, user interface module 32 may present one or more object rendering interfaces in GUI 50 that a user may access to change the manner in which one or more selected objects 206, 207 may be presented within GUI 50 before the objects may be incorporated into the story. For instance, the user may access a rotation interface 208 to rotate dog object 206 such that the object 206 may be presented in one or more perspective views within an area 214 on background 200. An example of a cat object 207 being rotated to be shown in several perspective views based on one or more user selections of rotation interfaces 208(1)-208(3) is shown in FIG. 6.

The user may access a scale interface 210 to change the size of the object 206 that may be incorporated into the story. Once the user has accessed rotation interface 208 and/or scale interface 210 to select the desired perspective view and/or size of dog object 206, for example, the user may select an integrate dog 212 interface to request story generating system 30 to position the dog object 206 at location 212 in background 200, although the dog object 206 may ultimately be positioned in background 200 at another location 215. Additionally, user interface module 32 may present one or more other interfaces (not illustrated) that may enable the user to associate a story caption or callout with one or more objects included in a portion of the story, such as dog callout 206′. The module 32 may present the user with one or more interfaces that may enable the user to handwrite the text to be included in the dog callout 206′, for example, although module 32 may present a text interface for enabling the text to be typed.

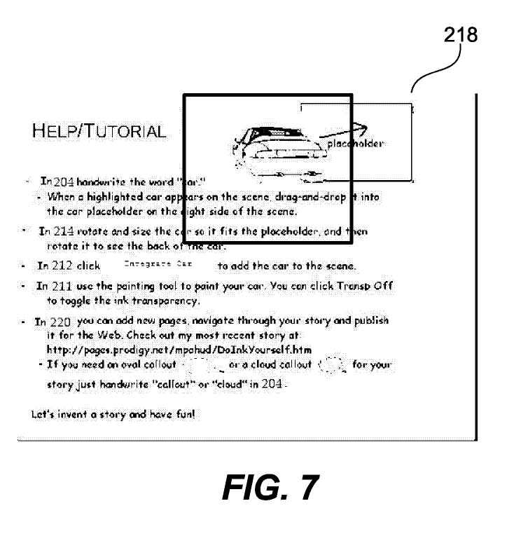

Users may also select a help/tutorial interface 216 in GUI 50 to obtain additional information or instructions on manipulating the graphical objects (e.g., objects 206, 207) while generating the story. Story generating system 30 may respond to a user's selection of help/tutorial interface 216 by instructing user interface module 32 to present one or more other user interfaces, such as user help/tutorial interface 218 shown in FIG. 7. When the user has finished incorporating their desired graphical objects, the user may add one or more additional pages or scenes 222 to the story by selecting the add new page interface 220 in GUI 50. Otherwise, the user may select publish my story interface 224.

Furthermore, if a collaborative communication session 310 is established at step 130, the user may request one or more other users involved in the collaboration to vote on whether the story may be changed in a particular manner proposed by the user by selecting the vote interface 400 in GUI 50, for example. For instance, the user may select vote interface 400 to request other users involved in the collaboration whether the dog object 206 may be added to the story in the location 212 on background 200 chosen by the user. An example of collaborative user interfaces 60(1)-60(2) presented by story generating systems 30 that may be implemented by computers 10 that may be operated by two users involved in a collaboration to generate a story are shown in FIG. 8. In this example, a first user of a first computer 10 in network 40 may select the vote interface 400 to request a second user of a second computer 10 in network 40 to vote on whether to add the dog object 206 in background 200.

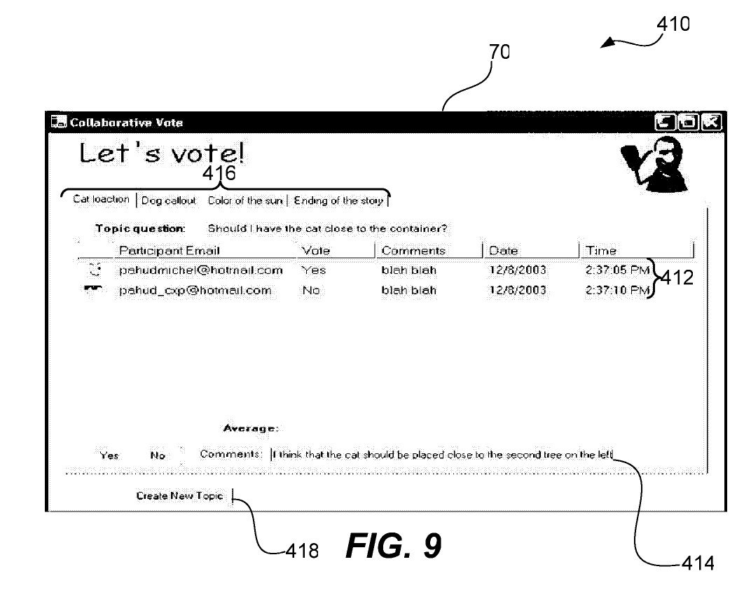

Responsive to a user selecting the vote interface 400 in GUI 50, for example, a story generating system 30 that may be implemented by each collaborating user at one or more other computers 10, as shown in FIG. 1, may establish a collaborative voting session 410 in the respective users' computer 10 each instructing their respective user interface modules 32 to present voting user interface 70 shown in FIG. 9. One or more collaborating user representations 412 may identify the users involved in the voting session 410, including the user's vote (e.g., yes, no), any comments the users may have submitted in connection with their vote, and the date and/or time their vote was submitted, for example. Still further, the story generating system 30 that may be implemented by the other computers 10 being operated by the collaborating users may provide additional functionalities for enhancing the collaborative voting session 410 where the computers may be coupled to different devices, such as video cameras.

By way of example only, the story generating systems 30 may provide real-time video functionality for enabling the collaborative users to see each other or to show each other different real-world objects that they may want to consider capturing for inclusion into a story being generated, for example. Such enhanced functionalities may captivate the attention of users, which may include young children with limited attention spans, and create a fun experience in which to generate stories. The story generating systems 30 on each of the computers 10 may leverage real-time video software to implement such functionalities, such as the ConferenceXP® 3.1 client®, which may be implemented on a number of operating systems, such as Microsoft® Windows® XP®, for example.

A user may submit comments in connection with their vote in a comments interface 414, although other users, such as moderators, may submit comments in the form of feedback to assist users with generating their story. Further, users may submit and/or view the voting information shown in FIG. 9 for one or more other portions of the story page depicted in GUI 50 from FIG. 5 by selecting one or more story element voting tabs 416, although users may create new voting topics for the story by selecting the create new topic interface 418. Responsive to the users' selections, the story generating system 30 that may be implemented by each collaborating users' machines may present the requested voting information and/or process submitted voting information.

At step 150, if the user selected the add new page interface 220 in GUI 50, user interface module 32 may instruct story generating system 30 that the user desires adding one or more additional pages or scenes 222 to the story, and the YES branch may be followed to repeat one or more of steps 110-140. Otherwise, the No branch may be followed to step 160. Furthermore, if a collaborative story session 310 may have been established at step 130, one or more of the users may navigate to one or more story scenes or pages indicated at scenes 222 in GUI 50 to modify it, for example, although a user generating a story individually may also navigate to a particular story scene to modify it in the same manner. Furthermore, the user interface modules 32 implemented on the computers 10 of the collaborating users in the collaborative story session 310 may all navigate to the same story scenes or pages indicated at scenes 222 in GUI 50 by one or more of the users to enable the users to collaboratively modify the story scene together.

At step 160, the user may request story interface module 32 to publish the story generated in steps 110-150 by selecting publish my story interface 224 in GUI 50. Responsive to the user's selection, story generating system 30 may render the one or more story pages or scenes 222 to create a rendered story comprising one or more image files that may be output or published by a variety of devices in one or more formats, such as by printing or display on a computer monitor or other suitable device, although the published story may comprise video media files, or the story may be published in other formats besides stories, such as documentaries, newsletters, slide presentations, or any other format. Further, story generating system 30 may publish the rendered story to one or more other devices over network 40, such as other computers 10, to allow the user to share their story with others, and the method 100 may end, although one or more portions of method 100 may be repeated.

It should be appreciated that the computer storage media described as computer memory module 20 in computer 10, illustrated in FIG. 2, may comprise one or more separate storage media distributed across a network. For example a remote computer may store one or more of the executable instructions, which when executed, may enable a device to implement the method 100 illustrated in FIG. 4. A local computer may access the remote computer and download at least a portion or the entire portion of the executable instructions. Moreover, the local computer may download one or more portions of the executable instructions as needed. It should also be appreciated that distributed processing techniques may be employed for executing the one or more executable instructions, such as by executing one or more portions of the instructions at the local terminal and executing one or more other portions of the instructions at the remote computer or elsewhere.

Further, while computer memory module 20 has been described above as comprising computer storage media, the memory module 20 should be broadly interpreted to cover communication media as well. Communication media may embody computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example only, communication media may include wired media, such as a wired network or direct-wired connection, and wireless media, such as acoustic, RF, infrared, other wireless media, and combinations thereof.

While the disclosed technology has been described above, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefor, is not intended to limit the claimed processes to any order except as may be specified in the claims.

What is claimed is:

1. At least one computer-readable medium having one or more executable instructions stored thereon, which when executed by at least one processing system, causes the at least one processing system to implement one or more story generation tools for assisting one or more users with generating at least one story, the one or more stored executable instructions comprising:
at least one story object module that obtains at least one selected story illustration element for including in the at least one story; and
at least one story interface module that presents one or more of a plurality of different representations of the at least one selected story illustration element responsive to at least one user request.

2. The medium as set forth in claim 1 wherein the at least one user interface module further comprises at least one representation manipulation module where at least one other user request can be made for manipulating at least one of a size property, perspective view property, or any other property of the at least one selected story illustration element.

3. The medium as set forth in claim 1 wherein the at least one user interface module requires the one or more users to identify the at least one selected story illustration element in a particular user input format before performing at least one of either obtaining or including the at least one selected story illustration element in the at least one story.

4. The medium as set forth in claim 3 wherein the particular user input format comprises an electronic handwriting input format.

5. The medium as set forth in claim 1 wherein the at least one user interface module identifies at least one expectation for the one or more users to meet when making the at least one user request.

6. The medium as set forth in claim 5 wherein the at least one expectation comprises at least one of correctly spelling information provided in connection with the at least one user request, using an electronic handwriting format for providing the information, or any other expectation implemented to teach or reinforce one or more educational related skills.

7. The medium as set forth in claim 6 wherein the at least one story interface module provides correct spelling information when information provided by the one or more users includes one or more spelling errors.

8. The medium as set forth in claim 1 wherein the at least one story illustration element comprises at least one three-dimensional perspective rendering of at least one object used to describe at least a portion of the at least one story.

9. The medium as set forth in claim 1 wherein the one or more stored executable instructions further comprise at least one story collaboration module that implements at least one of enabling the one or more users to simultaneously interact with each other while generating the at least one story, providing the one or more users with information describing one or more interactions of other collaborating users with the at least one story being generated, or any other action related to enabling the one or more users to collaborate with each other to generate the at least one story.

10. The medium as set forth in claim 1 wherein the one or more stored executable instructions further comprise at least one story feedback module that enables one or more collaborating users generating the at least one story to submit at least one vote relating to at least one decision to be made for which one or more proposed story interactions to implement on at least a portion of the at least one story.

11. A story rendering system that implements one or more story generation tools for assisting one or more users with generating at least one story, the system comprising:
at least one story object module that obtains at least one selected story illustration element for including in the at least one story; and
at least one story interface module that presents one or more of a plurality of different representations of the at least one selected story illustration element responsive to at least one user request.

12. The system as set forth in claim 11 wherein the at least one story interface module further comprises at least one input location where the at least one user request can be made.

13. The system as set forth in claim 11 wherein the at least one user interface module further comprises at least one representation manipulation module where at least one other user request can be made for manipulating at least one of a size property, perspective view property, or any other property of the at least one selected story illustration element.

14. The system as set forth in claim 11 wherein the at least one user interface module requires the one or more users to identify the at least one selected story illustration element in a particular user input format before performing at least one of either obtaining or including the at least one selected story illustration element in the at least one story.

15. The system as set forth in claim 14 wherein the particular user input format comprises an electronic handwriting input format.

16. The system as set forth in claim 11 wherein the at least one user interface module identifies at least one expectation for the one or more users to meet when making the at least one user request.

17. The system as set forth in claim 16 wherein the at least one expectation comprises at least one of correctly spelling information provided in connection with the at least one user request, using an electronic handwriting format for providing the information, or any other expectation implemented to teach or reinforce one or more educational related skills.

18. The system as set forth in claim 11 wherein the at least one story illustration element comprises at least one three-dimensional perspective rendering of at least one object used to describe at least a portion of the at least one story.

19. The system as set forth in claim 11 further comprising at least one story collaboration module that implements at least one of enabling the one or more users to simultaneously interact with each other while generating the at least one story, providing the one or more users with information describing one or more interactions of other collaborating users with the at least one story being generated, or any other action related to enabling the one or more users to collaborate with each other to generate the at least one story.

20. The system as set forth in claim 11 wherein the one or more stored executable instructions further comprise at least one story feedback module that enables one or more collaborating users generating the at least one story to submit at least one vote relating to at least one decision to be made for which one or more proposed story interactions to implement on at least a portion of the at least one story.
